(19) United States
(12) Patent Application Publication
(10) Pub. No.: US 2003/0234788 A1
(43) Pub. Date: Dec. 25, 2003

(54) Object shape transformation device

(76) Inventors: Akira Uesaki, Takatsuki-shi (JP); Yoshiyuki Mochizuki, Suita-shi (JP); Toshiki Hijiri, Hirakata-shi (JP); Katsunori Orimoto, Neyagawa-shi (JP); Toshikazu Ohtsuki, Kadoma-shi (JP); Shigeo Asahara, Ikeda-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/404,096

(22) Filed: Apr. 2, 2003

(30) Foreign Application Priority Data
Jun. 19, 2002 (JP) 2002-179241

(51) Int. Cl. G06T 15/70

(52) U.S. Cl. 345/473

(57) ABSTRACT

An object shape transformation device 10, for a start, accepts from a user a setting of shape information of an object at the time before and after the transformation and a parameter that controls growth potential affecting shape transformation of an object in a user interface unit 100. Then the device 10 calculates the growth potential required for shape transformation in a growth potential calculation unit 110 and decides a transformation path using the calculated growth potential in a growth path calculation unit 120. Next, the device 10 decides the shape of the object using the calculated transformation path and a temporal parameter in an object shape decision unit 130 and an object display unit 140 displays the object.

### BACKGROUND OF THE INVENTION

(1) Field of the Invention

The present invention relates to an object shape transformation device that transforms a shape of an object used in computer graphics and particularly to the object shape transformation device that controls a path in the case of transforming an object into another object.

(2) Description of the Prior Art

Computer graphics (hereafter called “CG”) are widely used and special effects realized by using CG are indispensable for creating video. Morphing, a technique that transforms smoothly from an object to another object, is its representative example. As the prior art on the shape transformation like this, there is “an action display generation method in computer graphics” disclosed by the Japanese Laid-Open Patent Application No. H8-55233.

In this conventional “action display generation method in computer graphics”, for a start, displacement vectors at the first time and the second time of points that make up of an object are sought. Next, based on the mixed function that indicates the mixture ratio between the displacement vectors at the first time and the second time of the point, the displacement vector at the predetermined time between the first time and the second time and the position vector of the point at the predetermined time are sought and they are displayed. A user can change the mixture ratio by controlling parameters.

In the above-mentioned prior art, however, the mixed function is given by a complex equation of motion using a direct current servo motor system, spring constant, attenuation coefficient and the like and therefore it is difficult for the user to understand the meaning of the function and operate the parameters intuitively. Further, as for the object of a character like a human being, for example, it is not unusual to construct a whole object by creating the arms and the legs as the independent segments and defining the hierarchical structure for them. The above-mentioned prior art cannot deal with the transformation of the object like this.

### SUMMARY OF THE INVENTION

In view of the foregoing, the present invention aims to provide an object transformation device that enables an ordinary user to change a transformation path for a shape of a CG object operating a parameter intuitively.

Further the present invention aims to provide the object transformation device that can transform a shape without damaging a hierarchical relationship even if a character has a hierarchical structure like the human structure.

To achieve the above-mentioned aims, the object shape transformation device is an object shape transformation device that controls transformation of an object shape in computer graphics comprising: a user interface unit operable to accept from a user a setting of (1) shape information of an object at time before and after the transformation and (2) a parameter that controls growth potential that is virtual force affecting shape transformation of the object; a growth potential calculation unit operable to calculate the growth potential based on the set parameter; a growth path calculation unit operable to calculate a transformation path of the object using the calculated growth potential; an object shape decision unit operable to decide a shape of the object at predetermined time using a parameter that represents the calculated path of the transformation and time between the time before and after the transformation; and an object display unit operable to display the object whose shape is decided. Herewith, the user can change the transformation path for the shape of the object operating the parameter intuitively.

Additionally, the object of the object shape transformation device is made up of one or plural segments; the user interface unit further accepts setting of a structural hierarchy among the segments, a relative position relationship and shape information of individual segments at the time before and after the transformation; the growth path calculation unit decides the transformation paths for the set individual segments; the object shape decision unit decides the shapes of the individual segments at the predetermined time; and the object shape transformation device further comprises a conversion matrix decision unit that decides the relative position relationship between the segments at the predetermined time. Herewith, it becomes possible to transform the shape without damaging the hierarchical relationship even if the object has the hierarchical structure like the human structure.

Furthermore, the user interface unit according to the present invention further accepts a setting specifying the structural hierarchy among the segments, the relative position relationship and the shape information of individual segments before the transformation and a setting specifying the shape information of the individual segments and the position information of the points where the individual segments connect with other segments after the transformation, and the conversion matrix decision unit changes the relative position relationship among the segments at the time before the transformation based on the shape of the individual segments calculated by the object shape decision unit.

Herewith, the user can select parts to be used to transform the shape to each segment that makes up the object. By so doing, it becomes possible to generate various objects with a simple operation.

By the way, to achieve the above-mentioned aims, it is possible to realize the present invention as an object transform method for having the characteristic structural units of the object shape transformation device as steps or to realize the present invention as a program including these steps. In addition, it is possible not only to store the program in ROM or the like that the object shape transformation device includes but also to distribute the program through the recording medium such as CD-ROM or the transmitting medium such as communication network.

Japanese patent application No. 2002-179241 filed on Jun. 19, 2002 is incorporated herein by reference.

### BRIEF DESCRIPTION OF THE DRAWINGS

These and other aims, advantages and features of the invention will become apparent from the following description thereof taken in conjunction with the accompanying drawings that illustrate a specific embodiment of the invention. In the Drawings:

FIG. 1 is a diagram that shows an example of a structure of an object shape transforming device according to the first embodiment.

FIG. 2 is a diagram that shows an example of a structure of a user interface unit according to the first embodiment.

FIG. 3 is a diagram that explains a physical movement in mass system.

FIG. 4 is a diagram that shows an example of a growth potential function in the directions of X-axis and Z-axis that operates on a vertex.

FIG. 5 is a diagram that shows an example of a growth potential function in the direction of Y-axis that operates on a vertex.

FIG. 6A is a diagram that shows an example of a growth potential function using different parameters.

FIG. 6B is a diagram that shows a moving path of a vertex using the different parameters.

FIG. 7A is a diagram that explains a coordinate system defined on the object.

FIG. 7B is a diagram that shows the manner in which the character is transformed in the direction of the height operating parameters α and β of the growth potential function Fy (t).

FIG. 7C is a diagram that shows the manner in which the character is transformed around the trunk operating the parameters α and β of the growth potential functions Fx (t) and Fz (t).

FIG. 8 is a diagram that shows an example of a structure of a user interface unit according to the second embodiment.

FIG. 9A is a diagram that explains names of each segment that makes up the object according to the second embodiment.

FIG. 9B is a diagram that explains a hierarchical structure of the object according to the second embodiment.

FIG. 10 is a diagram that shows an example of a structure of the object shape transformation device according to the second embodiment.

FIG. 11A is a diagram that explains a problem that occurs when the object with the hierarchical structure is transformed.

FIG. 11B is a diagram that shows a result of the transformation of the subject when the problem is resolved.

FIG. 12 is a flowchart that shows a series of processing of a conversion matrix decision unit according to the second embodiment.

FIG. 13A is a diagram that shows the case in which the connecting point matches the vertex that makes up a parent segment.

FIG. 13B is a diagram that shows the case in which the connecting point exists on a polygon that makes up a parent segment.

FIG. 14A is a diagram that shows the case in which the connecting point does not match the vertex that makes up the parent segment or does not exist on the polygon.

FIG. 14B is a diagram that explains the way to represent the coordinates of the connecting point using four vertexes that make up the parent segment.

FIG. 15 is a diagram that shows an example of a structure of the object shape transformation device according to the third embodiment.

FIG. 16 is a diagram that shows an example of a structure of a user interface unit according to the third embodiment.

FIG. 17 is a flowchart that shows a series of processing of a conversion matrix decision unit according to the third embodiment.

FIG. 18 is a diagram that shows an example of a structure of is the object shape transformation device according to the fourth embodiment.

FIG. 19A is an example of the object with a hierarchical structure used in the fourth embodiment.

FIG. 19B is an example that shows a conversion matrix among segments that have a parent-child relationship.

FIG. 20 is a flowchart that shows a series of processing that calculates a joint point in a joint point calculation unit.

FIG. 21 is a diagram that explains a calculation method of the joint point in the joint point calculation unit.

FIG. 22 is a diagram that explains a calculation method of the joint point when overlapping area does not exist.

### DESCRIPTION OF THE PREFERRED EMBODIMENT(S)

(The first embodiment)

An object shape transformation device according to the first embodiment of the present invention will be explained below with reference to figures. In addition, in the first embodiment, a three-dimensional character like a human being is cited as an example and explained as an object (i.e. an object put in the CG space), but the present invention is applicable to an arbitrary object. Additionally, the object used in the first embodiment shall be structured by a one-skin polygon model.

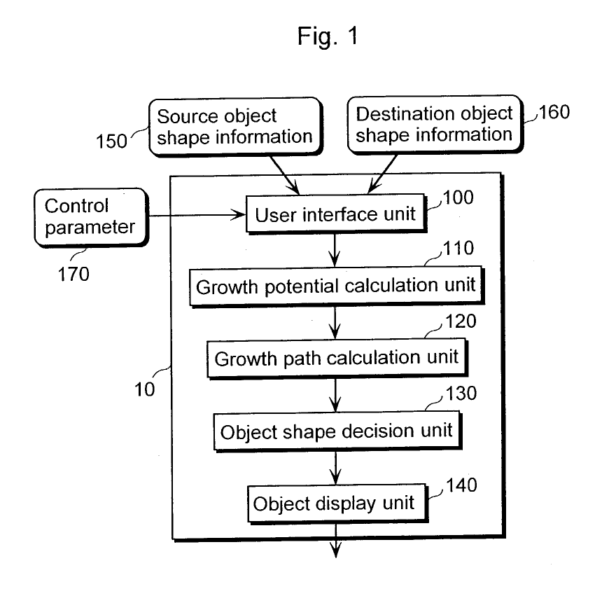

FIG. 1 is a diagram that shows an example of a structure of an object shape transforming device according to the first embodiment.

An object shape transformation device 10 according to the first embodiment comprises: a user interface unit 100; a growth potential calculation unit 110; a growth path calculation unit 120; an object shape decision unit 130; and an object display unit 140.

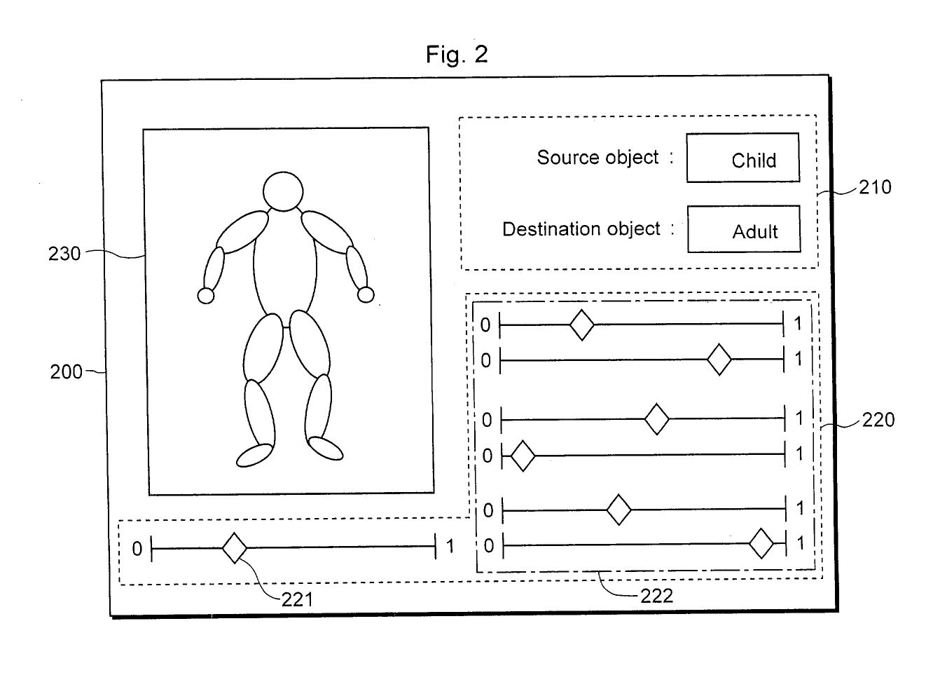

In the user interface unit 100, a user sets up source object shape information 150 that represents shape data before shape transformation, destination object shape information 160 that represents shape data after the transformation and a control parameter 170 that controls a transformation path. An example of the user interface unit is shown in FIG. 2. A user interface unit 200 shown in FIG. 2 is made up of an object shape information input unit 210, a parameter control unit 220 and an object display unit 230.

The object shape information input unit 210, for a start, receives specifications from the user of the object before the transformation (hereafter called “a source object”) and the object after the transformation (hereafter called “a destination object”). It is acceptable that the specification of the object is executed by a method to input the data name (or the file name) into an edit box or by a method to prepare a file dialog display button, for example, and to specify a desired object file from the file dialog. Next, the parameter control unit 220 receives a set-up of a parameter that controls a path of shape transformation.

In FIG. 2, out of the seven slider bars, a slider bar 221 is a temporal parameter, in other words, a slider bar that controls a parameter that represents a degree of the shape transformation from the source object to the destination object. Consequently, the state where the slider bar is at a position of 0 represents the source object. The state where the slider bar is at a position of 1 represents the destination object. The state between 0 and 1 represents an object at some midpoint in the transformation (hereafter called “a morphing object”). On the other hand, the six slider bars 222 other than the above-mentioned slider bar 221 control the path of the transformation. The role of each slider bar will be described later. By the way, in FIG. 2, the parameter control unit 220 is represented by using the slide bars, but it is acceptable to set up by a method to input a value directly into a prepared edit box or to be provided with both of them. Furthermore, in the first embodiment, six slide bars 222 are installed as shown in FIG. 2 because it depends on a processing method of the growth potential calculation unit 110, which will be described later and therefore the number is not particularly limited. The object display unit 230 displays a two-dimensional video of the object processed by the object display unit 140, (which explained later).

The growth potential calculation unit 110 calculates virtual force (hereafter called “growth potential”) to transform the shape from a source object to a destination object using the object and the control parameters set up in the user interface unit 100. Note that the correspondence among the vertexes that make up the source object and the destination object used in the first embodiment shall be determined in advance by a method of some kind but the method to determine is not particularly limited. The growth potential is determined uniquely as a function of a temporal parameter by the parameters set up in the parameter control unit 222. A calculation method of the function that represents the growth potential (hereafter called “a growth potential function”) is explained below.

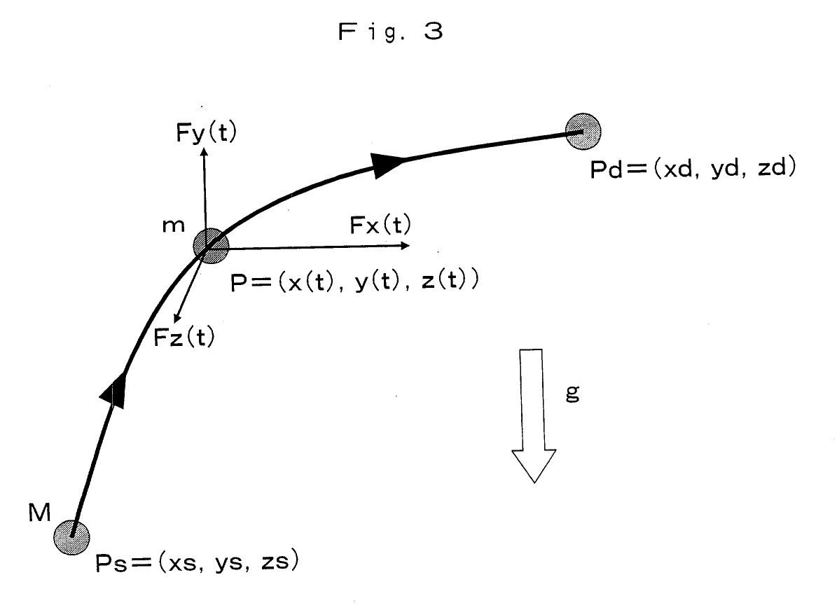

To explain a calculation method of the growth potential function, first let us think about the physical movement in the mass system. As shown in FIG. 3, let us think about the movement where a mass point M (mass m) that is in Ps=(xs, ys, zs) at the time t=0 moves to Pd=(xd, yd, zd) at the time t=1. When we suppose that the speed of the mass at t=0 and t=1 is 0 and define a gravitational field where the gravity g operates in the negative direction of Y-axis, the following equations of motion on the mass point hold.

m*ax(t)=Fx(t),

m*ay(t)=Fy(t)−m*g,

m*az(t)=Fz(t)

Here, a (t)=(ax(t), ay(t), az(t)) is the acceleration of the mass point M at the time t and F(t)=(Fx(t), Fy(t), Fz(t)) is the force that operates to the mass point M at the time t. Moreover, g is gravity while * represents a product. Further, as for the position of the mass point M (x(t), y(t), z(t)) and the speed (vx(t), vy(t), vz(t)), the following formulae hold. Let us call the following formulae restraint formulae.

$$( x ( 0 ) , y ( 0 ) , z ( 0 ) ) = ( xs , ys , zs ) , \\ ( x ( 1 ) , y ( 1 ) , z ( 1 ) ) = ( xd , y d , zd ) , \\ ( vx ( 0 ) , vy ( 0 ) , vz ( 0 ) ) = ( 0 , 0 , 0 ) , \\ ( vx ( 1 ) , vy ( 1 ) , vz ( 1 ) ) = ( 0 , 0 , 0 )$$

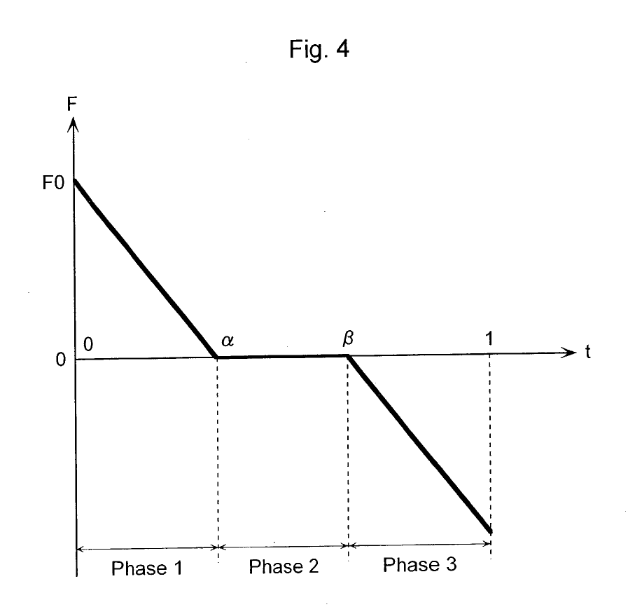

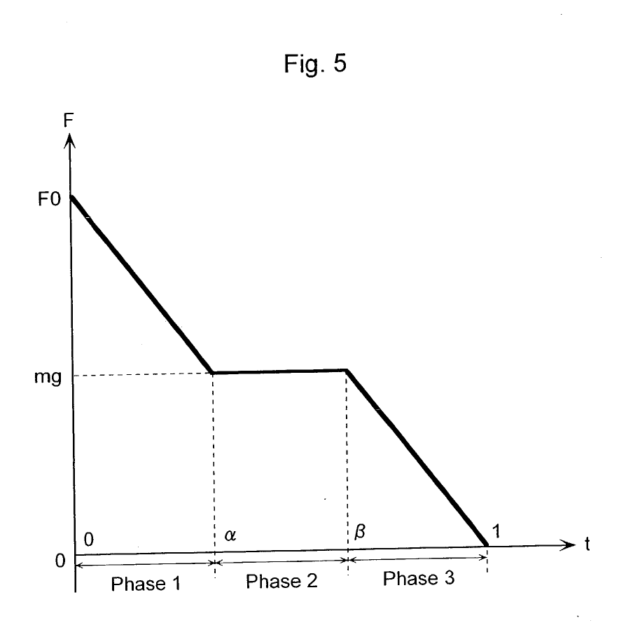

Next, let us think about force F(t) that satisfies the restraint formulae. Now, as the force F(t), let us define a function whose shape is shown in FIG. 4 concerning Fx(t) and Fz(t) and a function whose shape is shown in FIG. 5 concerning Fy(t). As shown in FIG. 4 and FIG. 5, the following relationship holds in each phase.

(Phase 1)

Fx(t)Fz(t):

As shown in FIG. 4, since F(t)=-FO/α*t+FO, a(t)=−FO*t /(m*a)+FO/m according to the equation of motion. Consequently, the speed v(t) shall be v(t)=−FO*t*t/(2*m*a)+FO*t/m by performing one integration to a (t) on the time t. Further, by performing the integration to v(t) from the time 0 to α, the moving distance P1 of the mass point M in Phase 1 shall be P1=FO*α*α/(3*m).

Fy(t):

As shown in FIG. 5, since F(t)=−(FO−m*g)*t/α+FO, a(t)=−(FO−m*g)*t/(m*a)+FO/m−g according to the equation of motion. By calculating according to a similar method to the case of Fx(t) and Fz(t), the moving distance P1 shall be P1=FO*α*α/(3*m)−g*α*α/3.

(Phase 2)

Fx(t),Fz(t):

As shown in FIG. 4, since F(t)=0 in Phase 2, it is understood that a uniform action is performed. Consequently, the speed v(t) of the mass point in Phase 2 is same as the speed v(a) of the mass point at the time t=α and becomes v(t)=v(α)=FO*α/(2*m). The moving distance P2 of the mass point M in Phase 2 shall be P2 =FO*α/(2*m)*(β−α).

Fy(t):

It is the uniform motion similarly to Fx(t) and Fz(t). Since v(t)=v(α)=FO*α/(2*m)−g*α/2, the moving distance P2 shall be P2=(FO*α/(2*m)−g*α/2)*(β−α).

(Phase 3)

Fx(t), Fz(t):

Since v(α)=FO*α/(2*m) and v(1)=0, the speed v(t) of the mass point in Phase 3 shall be v(t)=−FO*α/(2*m*(1−β)* (1−β))*(t−β)*(t−β)+FO*α/(2*m). Consequently, by performing the integration to v(t) from the time 0 to α, the moving distance P3 in Phase 3 shall be P3=−FO*α*(1−β)/(6*m)+FO *α/(2*m)−FO*α*β/(2*m).

Fy(t):

Since v(t)=(−FO*α/(2*m*(1−β)*(1−β))+g*α/(2* (1−β)*(1−β)))*(t−β)*(t−β)+FO*α/(2*m)−g*α/2 by a similar calculation to Fx(t) and Fz(t), the moving distance P3 shall be P3=FO*α/(3*m)−FO*α*β/(3*m)−g*α/3+g*α*β/3.

As described above, the following relationship holds as for the moving distance.

P1+P2+P3=Pd−Ps

According to the above-mentioned equation, it is understood that FO is uniquely determined when α and β are set. In other words, the moving path from Ps to Pd is determined.

In the growth potential calculation unit 110, a virtual mass point with the mass m is defined in each vertex that makes up the polygon of the object and a virtual gravitational field (gravitational acceleration: g) is defined in the space where the object exists. Then, the above-mentioned processing is executed to each vertex and F0 to move from a vertex coordinate in the source object to the vertex coordinate of the corresponding point in the destination object (hereafter called “initial growth potential”) is calculated. In so doing, by operating the slider bars 222 in FIG. 2, the values of a and βconcerning the force of each axis direction of Fx(t), Fy(t) and Fz(t) can be controlled. Consequently, by controlling α and β, the shapes of the initial growth potential and the growth potential function can be changed and as a result it is possible to change the path to transform the shape.

In the first embodiment, an example in which the combination of a linear function and a constant function is used as the growth potential function and the shapes of the growth potential function are controlled by six parameters α and β is described but the functions to be used and the number of the parameters is not particularly limited. Consequently, the growth potential function calculation unit 110 is generally explained as below.

(1) A function f (α[0], α[1], . . . , α[m−1], β) defined by m pieces of the control parameters α[0], α[1], . . . , a [m−1] and an undetermined variable β is defined as the growth potential function.

(2) A user sets up the control parameters α[0], α[1], . . . , a m−1.

(3) Solve the equation of motion described above and seek β.

An arbitrary function for which a solution of (3) exists can be used as the growth potential function f. Additionally, as for (3), when the equation of motion cannot be solved analytically, it is acceptable to use a numerical solution.

Next, the growth path calculation unit 120 and the object shape decision unit 130 are explained. In the growth path calculation unit 120, the position of each vertex at arbitrary time ta(0<=ta<=1) is calculated. Analytically, follow the procedures below.

(1) Using the initial growth potential F0 calculated by the growth potential calculation unit 110, define the growth potential function F(t).

(2) Solve the equation of motion and calculate the acceleration a(t).

(3) By performing one integration to a(t) on the time t, calculate the speed v(t).

(4) By performing one integration to v(t) from the time 0 to ta, calculate the distance d of the mass point at the time ta.

(5) Seek the coordinates P of each vertex at the time ta as P=Ps+d.

The processing of (1)˜(5) is executed in the x, y, z-axes directions of all the vertexes that make up the object.

In the case of executing the above-mentioned processing by a calculator, make the problem discrete and follow the procedures below.

(1) Divide the time 0 to 1 into N pieces of section and suppose that t[i](i=0, . . . , N, t[0]=0, t[N]=1). Furthermore, suppose that Δt=1/N.

(2) Using the initial growth potential F0 calculated by the growth potential calculation unit 110, define the growth potential function F(t).

(3) Solve the equation of motion and calculate the acceleration a[i] at the time t [i].

(4) Suppose that v[i+1]=v[i]+a[i]*Δt and calculate the speed v [i+1] at the time t [i+1]. Here v[0]=0

(5) Suppose that P[i+1] =P[i]+v[i+1]* Δt and calculate the coordinates of the vertex P[i+1] at the time t[i+1]. Here P[0]=Ps

(6) Repeat the procedures from (2) to (5).

Let us think about only the latter's case (a discrete system) below. When the coordinates at the set time t [k] is sought by executing the above-mentioned loop processing every time the user operates the slider bar 221 in FIG. 2 and the temporal parameters are changed, the load of calculation is heavy. Consequently, according to the first embodiment, in the growth path calculation unit 120, all the coordinates of each vertex at t [0]˜t [N] are calculated at the same time and the result is stored in a table. Then, in the object shape decision unit 130, when the temporal parameters are set up, the coordinates of the vertexes are decided by acquiring the data that match the parameters set up from the table. To be more specific, follow the procedures below.

(1) Store the coordinate data P[i] (i=0, . . . , N) of each vertex calculated by the growth path calculation unit 120 as the table.

(2) When the temporal parameters are changed and t=t [k] is set up, the data of P [k] is acquired from the table. Here, k is an integer between 0 and N.

In the first embodiment, using the object shape decision unit 130, we try to achieve the reduction of the calculation load and the speeding up of the calculation of the vertex coordinates, but it is acceptable to not use the object shape decision unit 130 when the memory area is limited or when hardware that can realize fast processing in the growth path calculation unit 120 is equipped.

In the object display unit 140, rendering processing of an ordinary three-dimensional CG is executed and the generated object is displayed. To be more specific, the following processing is executed.

(1) Coordinate transformation (modeling transformation, visual field transformation and the like)

(2) Shading

(3) Texture mapping

Finally generated two-dimensional image is displayed on the object display unit 230 in FIG. 2.

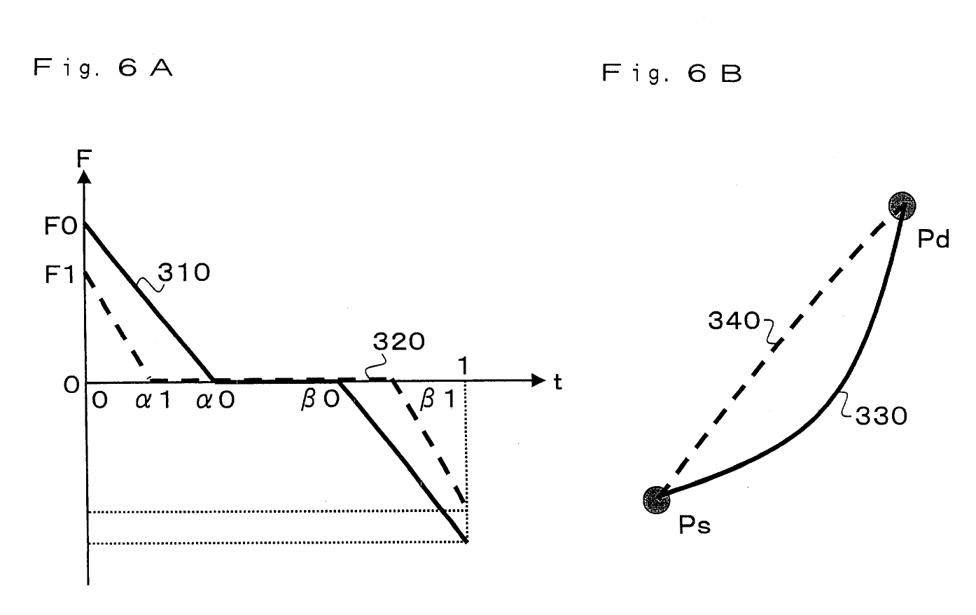

An intuitive control method of the control parameters in the first embodiment is explained below. As described above, in the first embodiment, the user can change α and β in FIG. 4 and FIG. 5 by operating the slider bar 222 shown in FIG. 2. An example in which the shape of the growth potential function changes as a result of the user's operation of the control parameters is shown in FIG. 6A.

For a start, the physical meaning about FIG. 6A is explained. Both of the growth potential functions 310 and 320 have a positive value in the phase at the time 0 to α, have zero in the phase at the time α to β and have a negative value in the phase at the time β to 1. The difference of the two appears in the positions of the parameters α and β. When the parameters α0 and β0 of the growth potential function 310 are compared with the parameters α1 and β1 of the growth potential function 320, α1 is set up to be in the nearer position to 0 than α0 and β1 is set up to be in the nearer position to 1 than β0. That the growth potential function is positive means that the movement of the vertex is accelerated and therefore the larger the value is, the more rapidly the shape changes. Furthermore, when the growth potential function is negative, the smaller the value is, the more rapidly the movement quantity of the vertex decelerates. Consequently, it can be said that α and β in FIG. 4 and FIG. 5 are the parameters that set up the section in which the shape changes rapidly and the section in which the shape changes mildly, respectively. Since the growth potential function 320 has a longer phase in which the shape changes with constant speed than the growth potential function 310, the growth potential function 320 transforms from the vertex position of the source object to the vertex position of the destination object through a path that is close to a straight line.

In FIG. 6B is shown the transformation path from the vertex Ps of the source object to the vertex Pd of the destination object when the growth potential functions 310 and 320 are used as Fx(t). In FIG. 6B, the transformation path 330 is the path when the growth potential function 310 is used, while the transformation path 340 is the path when the growth potential function 320 is used.

Here, specific explanation about a manner by which the object transforms (grows) actually by the above-mentioned growth potential function is made.

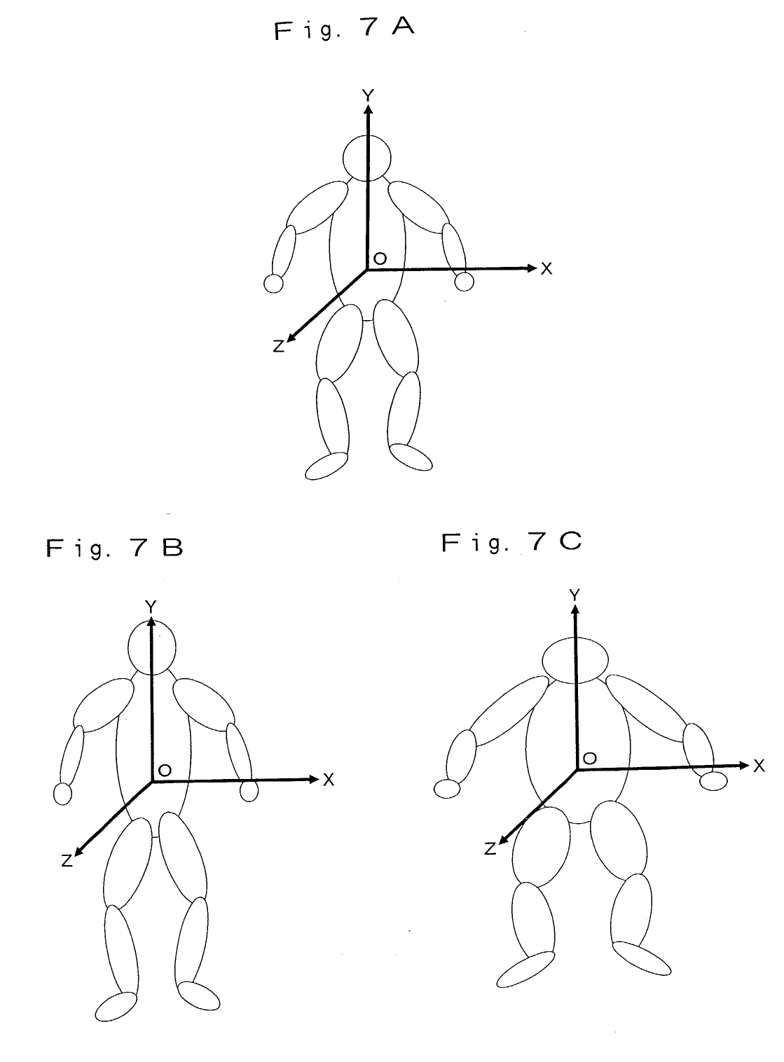

FIG. 7A is a diagram that explains a coordinate system defined on the object. As shown in FIG. 7A, an original point 0 is set to the gravity point of an object; X-axis is defined in the horizontal direction to the base level and in the direction to the left arm; Y-axis is defined in the vertical direction to the base level and in the direction to the head; and Z-axis is defined in the vertical direction to these axes to be a right-hand coordinate system. Defining these coordinate systems, it is understood that the movement of the vertex in the direction of X-axis and Z-axis represents a transformation around the trunk and the movement of the vertex in the direction of Y-axis represents a transformation of the vertical direction, namely the height. Consequently, the user can understand intuitively that he can control the transformation in the direction of the height of the object by operating the parameters a and β of the growth potential function Fy(t) (refer to FIG. 7B) and he can control the transformation around the trunk of the object, in other words the body shape by operating the parameters a and β of the growth potential functions Fx(t) and Fz(t) (refer to FIG. 7C).

As described above, in the first embodiment, it is possible to generate various transformation paths of the object by controlling a small number of the parameters. Further, since the conception of force familiar to an ordinary user is used as the indicator to control the path of shape formation, the object shape transformation device is easy to operate intuitively.

(The second embodiment)

An object shape transformation device according to the second embodiment of the present invention will be explained below with reference to figures. In addition, in the second embodiment, as an object, a character like a human being who has a hierarchical structure is cited as an example and explained but the present invention is applicable to an arbitrary object that has a hierarchical structure. An object used in the second embodiment shall be made up of the head, the arms, the legs and the body; each of them is an independent segment and is connected according to the hierarchical structure. Additionally, the hierarchical structure of the source object matches that of the destination object. Here, “segments” are display elements that make up the above-mentioned object and are operable as one. Further, similarly to the first embodiment, as for the source object and the destination object used here, correspondence among the vertexes of each segment shall be determined in advance. For each segment, the names are defined and basically the segment that has the structurally same position in the source object and the destination object shall have the same name but there may be an exception. When the different names are used, the name defined for either of the source object or the destination object shall be used.

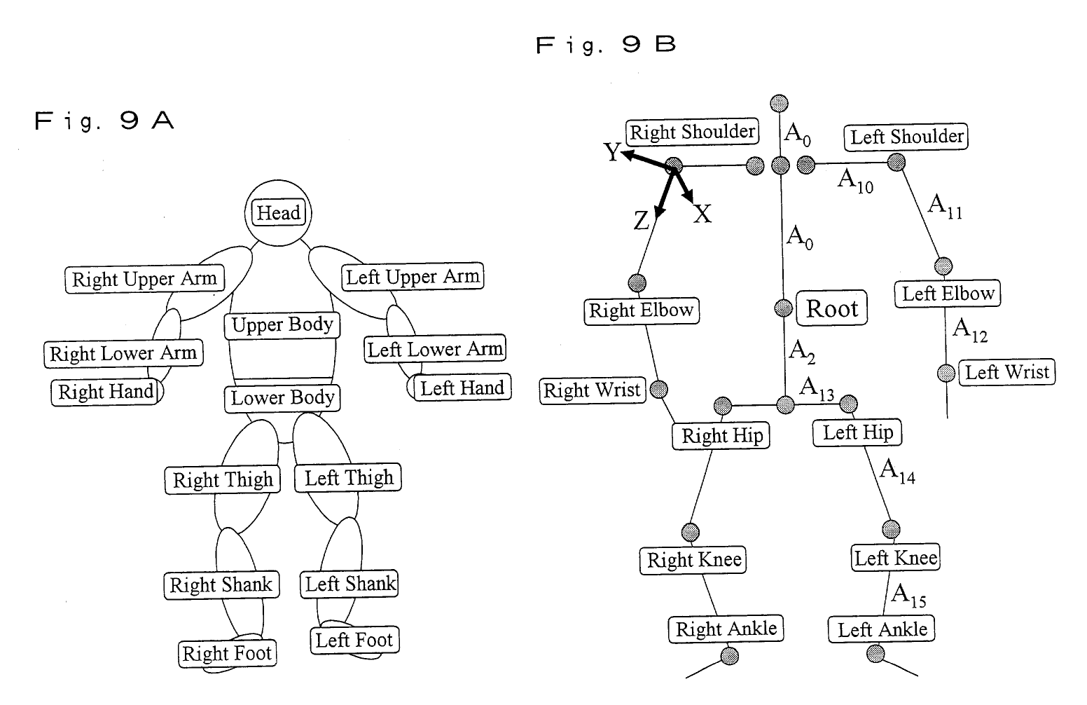

The names for each segment of the object and the hierarchical structure relationship used in the second embodiment are shown in FIG. 9. The present object is made up of 15 segments and the name for each segment is defined (FIG. 9A). Additionally, a hierarchical structure defined to correspond to FIG. 9A is shown in FIG. 9B and a local coordinate system is defined for a joint point for each segment. Here, the “joint point” is the point where the neighboring segments are linked (also called “connecting point”).

In the second embodiment, as shown in the Right Shoulder in FIG. 9B, the local coordinate system shall be defined in order that the direction to the joint point of the segment that is its own child matches the Z-axis of the local coordinate system but there may be an exception. For example, when the origin point of the local coordinate system set up in each segment does not match the joint point, a method for matching the origin point with the connection point by executing a coordinate conversion in advance is thinkable. In FIG. 9B, Aji (j and i are integers) is a homogeneous conversion matrix that converts an expression in the child local coordinate system into an expression in the parent local coordinate system. For example, “All” is the homogeneous conversion matrix that converts the expression in Left Elbow (or Left Lower Arm in FIG. 9A) coordinate system into the expression in Left Shoulder (or Left Upper Arm in FIG. 9A) coordinate system. The homogeneous conversion matrix includes three elements: a translating component; a rotation component; and a scaling component, but in the second embodiment, only the shape transformation of the object is dealt and therefore the rotation component shall not be considered. In other words, the rotation component of the homogeneous conversion matrix shall be 0 or when it is not 0, the rotation component of the homogeneous conversion matrix that corresponds to the source object shall have the same value as that of the homogeneous conversion matrix that corresponds to the destination object. Furthermore, as for the scaling component, it is possible to treat it as the translating component by multiplying it to the coordinates of each vertex of the segment in advance. Consequently, as for the homogeneous conversion matrix used in the second embodiment, only the translating component is considered.

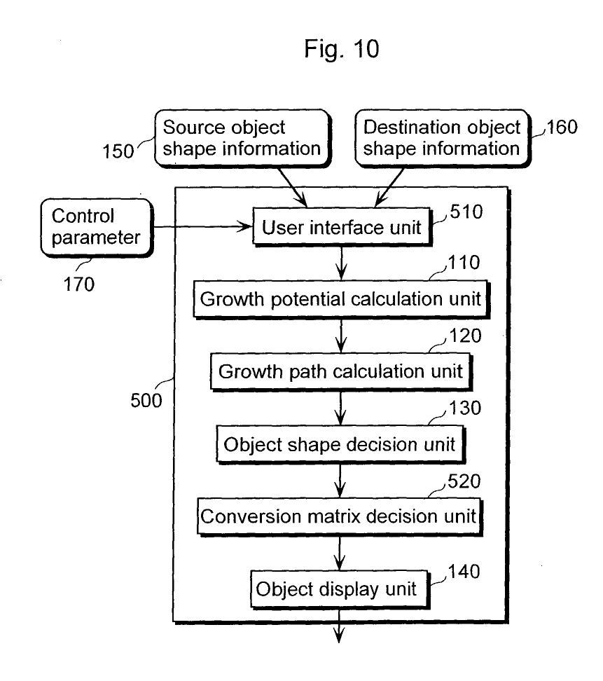

FIG. 10 is a diagram that shows an example of a structure of the object shape transformation device according to the second embodiment. The object shape transformation device 500 comprises a user interface unit 510 and a conversion matrix decision unit 520. Note that in FIG. 10, the same parts in FIG. 1 are given the same numbers and their explanations are omitted.

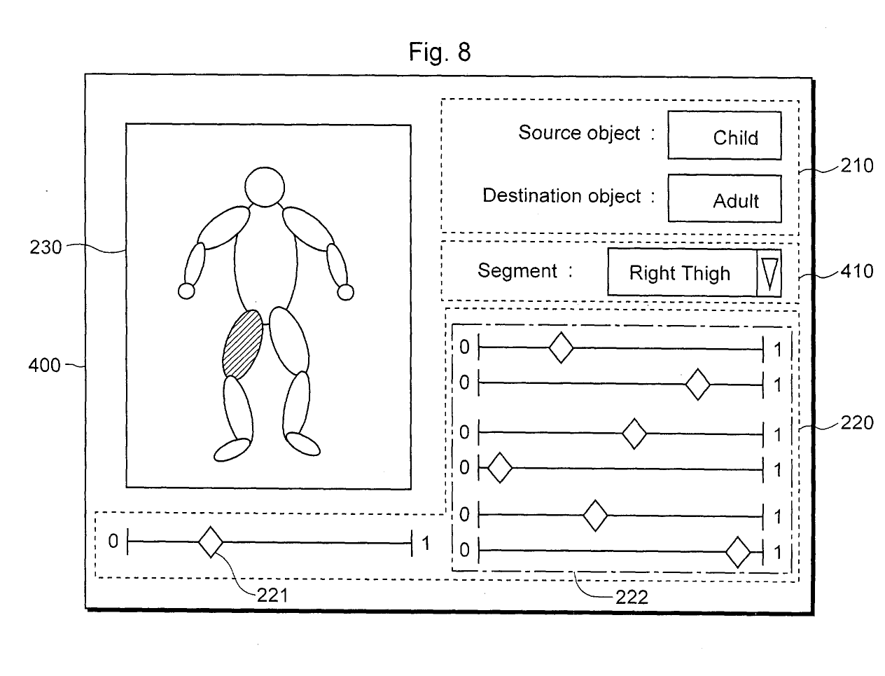

FIG. 8 is a diagram that shows an example of the user interface unit 510 according to the second embodiment. A user interface unit 400 in FIG. 8 includes a segment selection unit 410 in addition to the functions shown in FIG. 2. By the way, in FIG. 8, the same parts in FIG. 2 are given the same numbers and their explanations are omitted.

Since the object according to the second embodiment is made up of a set of segments, it is possible to set up a transformation path for each segment. Based on the user's instruction, the user interface unit 510 stores source object shape information 150 and the destination object shape information 160, and sets up a transformation parameter through a segment selection unit 410. In addition, since the source object shape information 150 and the destination object shape information 160 include information on the hierarchical relationship of each segment and on the homogeneous conversion matrix that defines the relative position relationship among the segments, the user interface unit 510 stores the homogeneous conversion matrix at the same time when the above-mentioned shape information 150 and 160 are specified. The name of each segment included in the source object shape information 150 by the user in advance is registered in the segment selection unit 410. Further, by receiving the selection of the segment names and the operations of the slider bars 222 from the user, the user interface unit 510 sets up the transformation parameters to the selected segments. After the setting for all the segment names have finished and when the user's operation of the slider bar 221 is accepted, the object display unit 230 displays the objects that change according to the change of a display time parameter. By the way, the growth potential calculation unit 110, growth path calculation unit 120 and the object shape decision unit 130 are similar to the first embodiment.

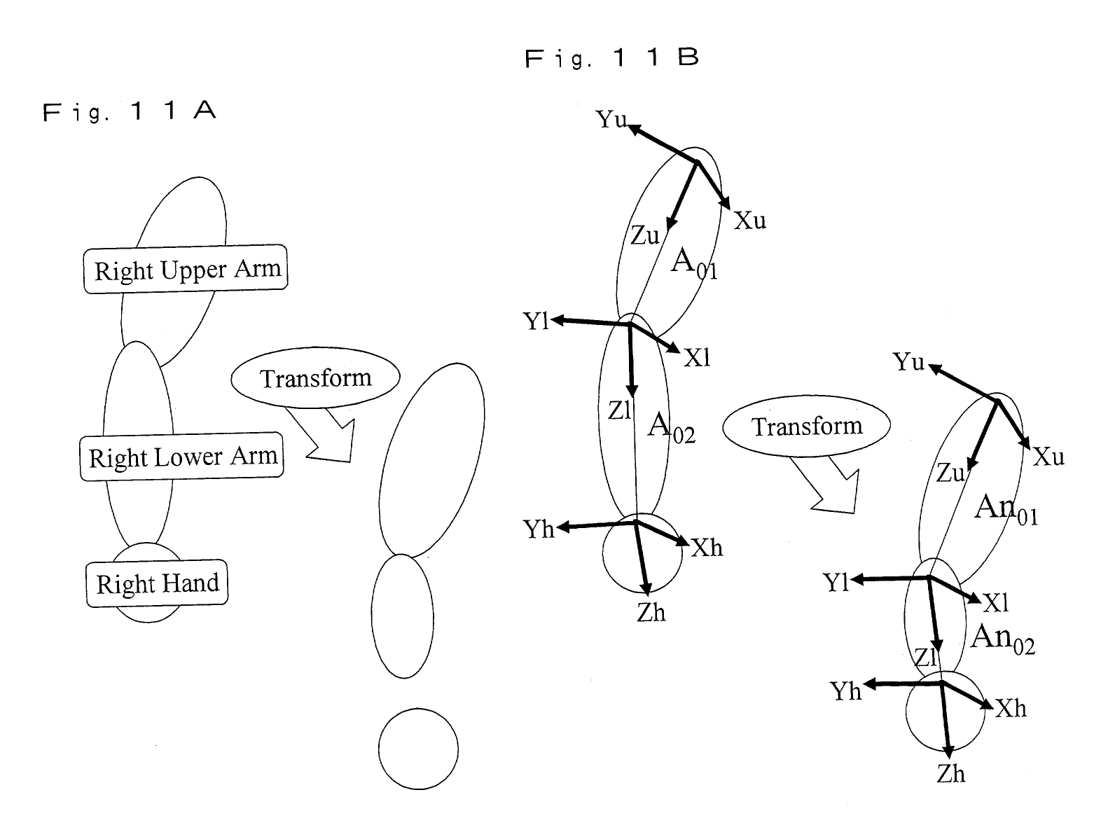

Next, a conversion matrix decision unit 520 is explained. As is described above, in the second embodiment, it is possible to set up the transformation path for each segment. Now, as shown in FIG. 11, let us think about transforming the shape of Right Lower Arm. Just transforming the shape of Right Lower Arm, there is a possibility that Right Hand breaks away from Right Lower Arm as shown in FIG. 11A. Consequently, it is necessary to correct the homogenous conversion matrix that represents the relationship between the local coordinate systems in agreement with the shape transformation and to generate the state shown in FIG. 11B. A way to correct the homogeneous conversion matrix is described below.

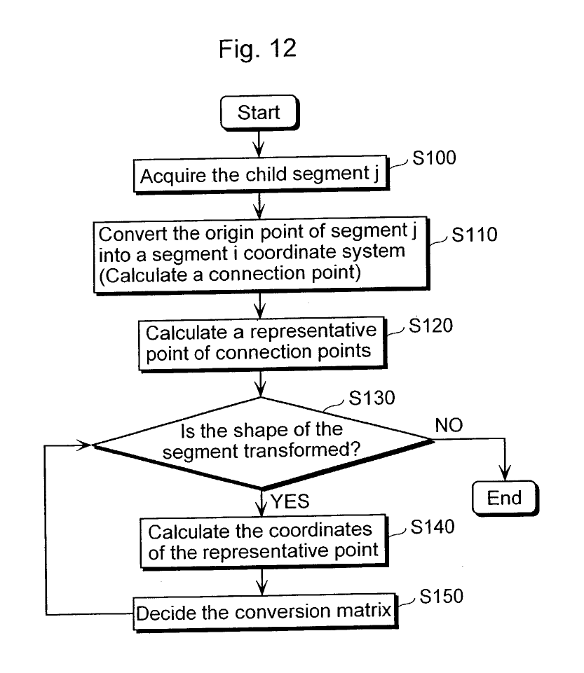

FIG. 12 is a flowchart that shows the correction processing of a homogeneous conversion matrix Ai that corresponds to a segment i. Here, the homogenous conversion matrix that corresponds to the segment i of the source object shall be Asi; the homogenous conversion matrix that corresponds to the segment i of the destination object shall be Adi; and the translating components of Asi and Adi shall be (xsi, ysi, zsi) and (xdi, ydi, zdi), respectively. For a start, as for the segment i of the source object, the child segment j is acquired (S100). Then, at S110, the coordinate Oj of the origin point of the segment j is converted into a representation Oji in a segment i local coordinate system. In S120, we seek the point whose distance from Oji is shortest among the vertexes that make up the segment i and make this point a representative point P sp=(xsp, ysp, zsp). In addition, here, make the point whose distance is shortest the representative point but the decision method is not limited. For example, it is possible to make the point sought by the below-mentioned method the representative point.

(1) Seek the equation I of a straight line passing through the coordinates Oi of the origin point of the segment i and Oji.

(2) Calculate the polygon that crosses the straight line I and is nearest to Oji among the polygons that make up the segment i.

(3) When the straight line I crosses the polygon that is made up of three points, Pi0, Pi1 and Pi3, the representative point P shall be P =α*Pi0+β*Pi1+γ*Pi2. Here, α, β and γ are real numbers that satisfy O≦α≦1, 0≦β≦1, 0≦γ≦1, α+β+γ=1 and * represents a product of the vector and the constant.

In the second embodiment, the correction of the conversion matrix Ai is executed based on the movement of this representative point. Now, suppose that the shape of the segment i transforms at the time t (S130). At S140, calculate the coordinates Pcp=(xcp, ycp, zcp) of the representative point that is calculated at S120 at the time t. Then, at S150, the conversion matrix at the time t is decided following the procedures below. Here, the coordinates of the representative point of the destination object shall be Pdp=(x dp, ydp, zdp).

(1) Seek dx, dy, dz, the ratio of change in each of x, y and z components by dx=(xcp−xsp)/(xdp−xsp), dy=(ycp−ysp)/(ydp−ysp), dz=(zcp−zsp)/(zdp−zsp)

(2) Seek (xi, yi, zi), the translating component of the homogeneous conversion matrix Ai at the time t by xi=(1−dx)*xsi+dx*xdi, yi=(1−dy)*ysi+dy*ydi, zi=(1−dz)*zsi+dz*zdi.

The above-mentioned processing is executed to each conversion matrix from the conversion matrix that corresponds to Root in FIG. 9 in consequence to the child following the hierarchical structure. The processing is not executed to the homogeneous conversion matrix that corresponds to the segment that does not have a child.

As is described above, in the second embodiment, as for the objects that have the hierarchical structure, the user interface unit is included that can set up the transformation parameter for each segment that makes up the object and therefore the user can control the transformation path for each segment. Further, the conversion matrix decision unit is included that solve the problem that a displacement occurs in relative position relationship among the segments because of the shape transformation. Consequently, the user can control the transformation easily even if the object is a human character whose each part is structured as an independent segment and is connected following the hierarchical structure.

(The Third Embodiment)

An object shape transformation device according to the third embodiment of the present invention will be explained below with reference to figures. In addition, a source object used in the third embodiment is a character object that has the hierarchical structure similar to that used in the second embodiment (refer to FIG. 9). As for the object used for the transformation of each part (hereafter called “a parts object”), the correspondence between the segments and vertexes of the source object that corresponds to the parts object shall be determined in advance.

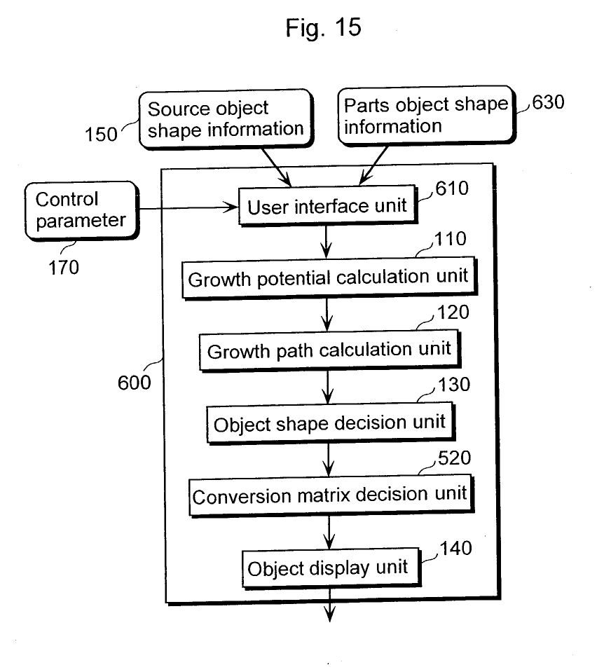

FIG. 15 is a diagram that shows an example of a structure of the object shape transformation device according to the third embodiment. An object shape transformation device 600 comprises a user interface unit 610 into which parts object shape information 630 can be inputted in addition to the source object shape information 150 and the control parameter 170. Note that in FIG. 15, the same parts in FIG. 1 are given the same numbers and their explanations are omitted.

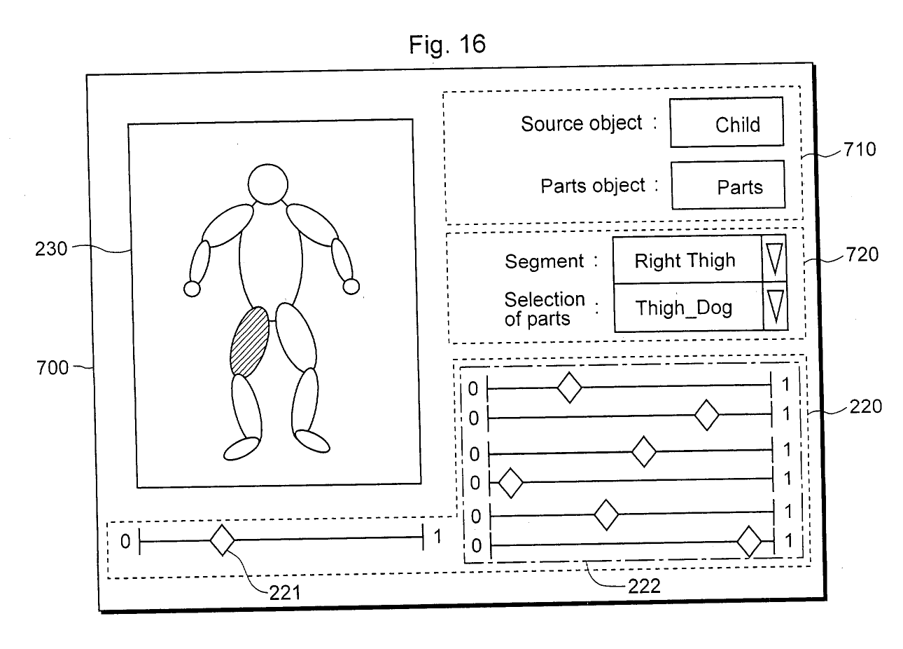

FIG. 16 is a diagram that shows an example of a structure of a user interface unit 610 according to the third embodiment. A user interface unit 700 is equipped with an object shape information input unit 710 and a segment parts selection unit 720. Note that in FIG. 16, the same parts in FIG. 2 are given the same numbers and their explanations are omitted.

In the parts object shape information 630 is stored shape information of the parts object used for the shape transformation of each segment that makes up the source object. The parts object shape information 630 of the third embodiment differs from the destination object shape information 160 of the second embodiment in that the former includes only shape data of each parts object and does not include the information of the hierarchical structure. Here, in the parts object shape information 630, the coordinates of the joint points that connect other segments are defined for each segment in the local coordinate systems. By the way, it is acceptable that the parts object information 630 includes information of plural parts objects that is usable to transform one object but it is necessary that correspondence relationship among all the vertexes is sought. Additionally, the object shape information input unit 710 has only one section to set up the parts object shape information but it is not particularly limited and it is acceptable that plural pieces of parts object shape information are set up. In the segment parts selection unit 720, similarly to the second embodiment, for a start, a segment is set up to set up the transformation parameter and after that the parts object used for the transformation is selected. When only one parts object that can be used to transform is included in the parts object shape information 630, it is automatically decided to use the said parts object. FIG. 16 shows an example that the data of parts object defined as Thigh_Dog and stored in a file called Parts is used to transform the shape of Right Thigh segment of the source object. The user can set up the transformation path by specifying the parts object used for the transformation and further operating the slide bars 222.

As for the growth potential calculation unit 110, the growth path calculation unit 120 and the object shape decision unit 130, they are similar to those of the first embodiment.

The conversion matrix decision unit 520 is explained below. In the third embodiment also, since the shape is transformed for each segment, a displacement occurs in relative position relationship among the segments. Consequently, it is necessary to change the homogenous conversion matrix defined in the source object. By the way, because of the similar reason to the second embodiment, in the third embodiment also, only the translating component is considered.

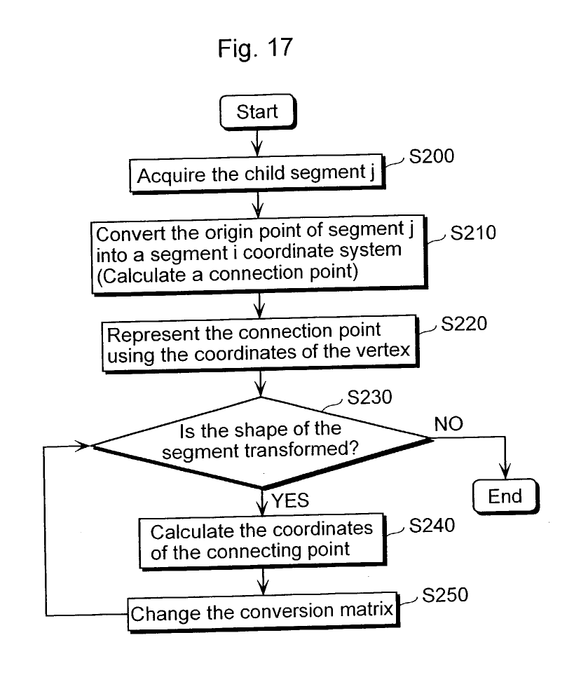

FIG. 17 is a flowchart that shows processing to correct the homogenous conversion matrix Ai that corresponds to the segment i of the source object. At S200, for a start, a segment j that is a child of the segment i in the source object is acquired. Next, at S210, the coordinates Oj of the origin point of the segment j is converted into the representation Oji. Hereafter Oji is called “the connection point” or “the joint point. At S220, the coordinates of the connecting point Oji is represented using the vertexes that make up the segment i. As for a method for representing the connection point, it differs depending on the position where the connection point exists but the method is not particularly limited. Three cases are explained below.

Here, local coordinate systems set up in the segments i and j shall be coordinate systems I and J, respectively; the homogenous conversion matrix that converts the representation in the local coordinate system I into the local coordinate system J shall be As; and the translating component of As shall be (xs, ys, zs). Under the above-mentioned setting, the three cases in which the shape of the segment i changes are considered.

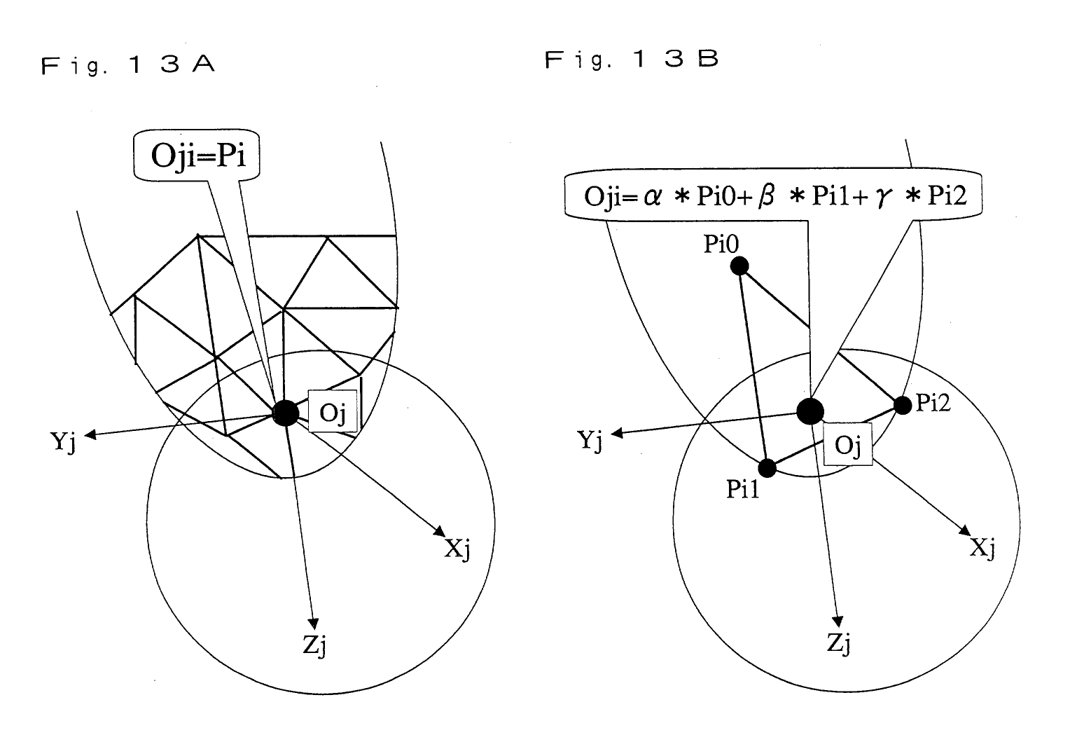

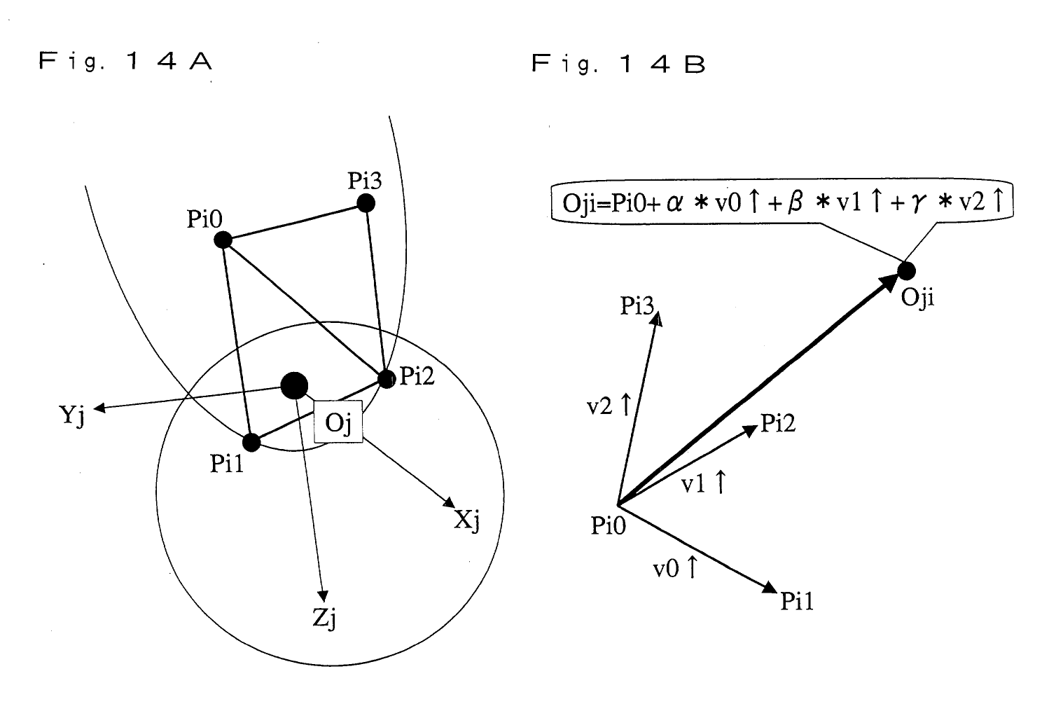

(The case in which the connection point matches a vertex that makes up the segment) (FIG. 13A)

For a start, the case in which the connection point Oji matches the vertex that makes up the segment i is explained. Now, when the connection point Oji matches a vertex Pi of the segment i, the coordinates of the connection point Oji=(xsji, ysji, zsji) shall be Oji=Pi.

(The case in which the connection point exists on one of the polygons that make up the segment) (FIG. 13B)

Now, the case in which the connection point Oji exists on one of the polygons that make up the segment i is explained. Suppose that Oji exists on the polygon that is made up of three points Pi0, Pi1 and Pi2. The connection point Oji=(xsji, ysji, zsji) shall be Oji=α*Pi0+β*Pi1+γ* Pi2. Here, α, β and γ are real numbers that satisfy 0<=α<=1, 0<=β<=1, 0<=γ<=1, α+β+γ=1 and * represents a product of the vector and the constant.

(The case in which the connection point exists in an arbitrary coordinate) (FIG. 14)

In the case in which the connection point is not applicable to neither of the above, the coordinates of the connection point Oji is calculated using four arbitrary vertexes among the vertexes that make up the segment i. To be more specific, follow the procedures below.

(1) Select four arbitrary vertexes that do not exist in one plane among the vertexes that make up the segment i. The selection method is not particularly limited but it is thinkable that selecting vertexes that are far from the connection point Oji in distance may cause a large error in the following processing and the correct coordinates cannot be obtained in some cases, and therefore it is generally preferable to select vertexes that are near to the connection point Oji in distance. To be more specific, the following methods are thinkable.

(Method 1)

(i) Select the four vertexes that are nearest to Oji and do not exist in one plane.

(Method 2)

(i) Seek the nearest polygon to Oji and select three vertexes.

(ii) Seek the distance among vertexes adjacent to the three vertexes sought in (i) and Oji; make the vertex whose distance is shortest and that does not exist in one plane with the three vertexes the fourth vertex.

(2) Suppose that the selected four vertexes are Pi0, P1, Pi2 and Pi3. Acquire three spatial vectors, v0↑=Pi1−Pi0, v1↑=Pi2−Pi0 and v2↑=Pi3−Pi0. Here, ↑represents a vector (refer to FIG. 14B).

(3) Represent Oji using v0↑, v1↑ and v2↑.

Oji=Pi0+α*v0↑+β* v1↑+γ*v2↑

Here, α, β and γ are real numbers and * represents a product of the vector and the constant.

Next, when the shape of the segment i at the time t transforms (S230), calculate the coordinates of the connection point at that time and change the homogenous conversion matrix. Corresponding to S220, three cases of processing at S240 and S250 are explained.

(The case in which the connection point matches a vertex that makes up the segment) (FIG. 13A)

When the shape of the segment transforms at the time t and that Pi becomes Pic, the coordinates of the connection point Ocji=(x cji, ycji, zcji) is Ocji=Pic. Consequently, the translating component of the homogeneous conversion matrix Ac at the time t (xc, yc, zc) shall be (xc, yc, zc)=(xs+xcji−xsji, ys+ycji−ysji, zs+zcji−zsji).

(The case in which the connection point exists on one of the polygons that make up the segment) (FIG. 13B)

When the shape of the segment transforms at the time t and the coordinates of three points Pi0, Pi1 and Pi2 become Pic0, Pic1 and Pic2, the connection point Ocji=(xcji, ycji, zcji) is Ocji=α* Pic 0+β* Pic1+γ* Pic2. For this reason, the translating component of the homogeneous conversion matrix Ac at the time t, similarly to the above-mentioned case, shall be (xc, yc, zc)=(xs+xcji−xsji, ys+ycji−ysji, zs+zcji−zsji).

(The case in which the connection point exists in an arbitrary coordinates) (FIG. 14)

When the shape of the segment transforms at the time t and the coordinates of four points Pi0, Pi1, Pi2 and Pi3 become Pic0, Pic1, Pic2, Pic3, the connection point Ocji=(xcji, ycji, zcji) can be represented as Ocji=Pic0+α* vc0↑+β* vc1↑+γ* vc2↑, using three spatial vectors vc0↑=Pic1−Pic0, vc1↑=Pic2−Pic0, vc2↑=Pic3−Pic0. Consequently, the translating component of the homogeneous conversion matrix Ac at the time t shall be (xc, yc, zc)=(xs+xcji−xsji, ys+ycji−ysji, zs+zcji−zsji).

As is described above, in the third embodiment, to each segment that makes up the source object, it is possible to select a parts object to use the transformation of the shape. For this reason, the user can generate objects with various shapes by a simple operation.

(The Fourth Embodiment)

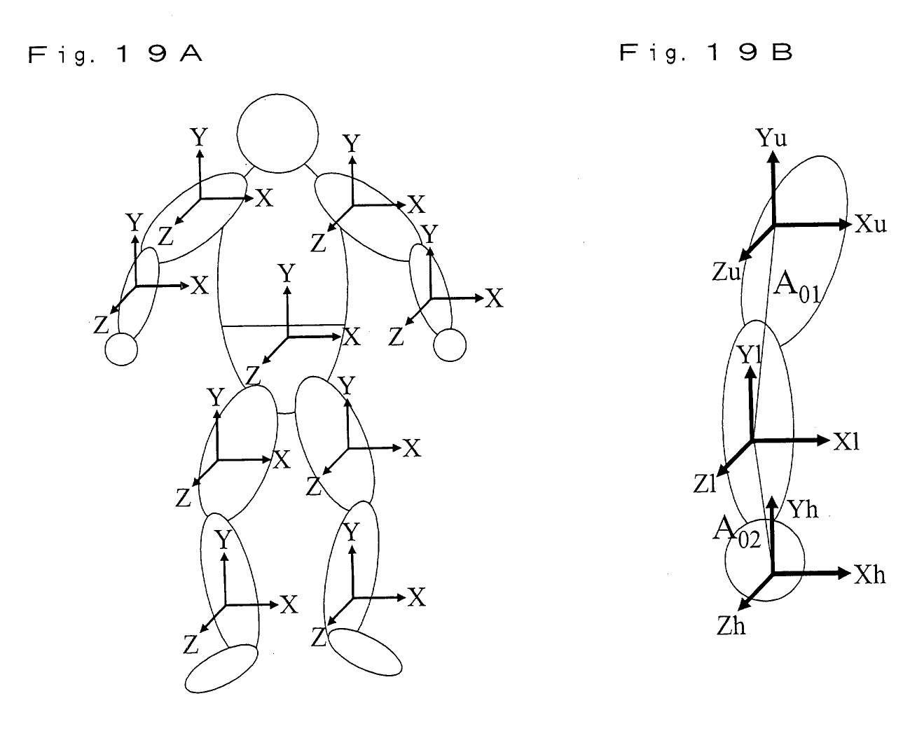

An object shape transformation device according to the fourth embodiment of the present invention will be explained below with reference to figures. In addition, in the fourth embodiment, a character like a human being who has a hierarchical structure is cited as an example and explained but the present invention is applicable to an arbitrary object that has a hierarchical structure. An object used in the fourth embodiment shall be an object that is made up of the head, the arms, the legs and the body; each of them is an independent segment and is connected according to the hierarchical structure. Additionally, the hierarchical structure of the source object matches that of the destination object. Here, in the fourth embodiment, differently from the second embodiment and the third embodiment, the origin point of the local coordinate system defined for each segment does not match the joint point and is set up at an arbitrary position. FIG. 19A is an example of the object like this. FIG. 19B is an example of the conversion matrix between the segments that has a parent-child relationship. For example, A01 is a homogeneous conversion matrix that converts the representation in “Right Lower Arm” coordinate system into that in “Right Upper Arm” coordinate system. The homogeneous conversion matrix includes three elements: a translating component; a rotation component; and a scaling component, but because of the similar reason to the second embodiment, as for the homogeneous conversion matrix used in the fourth embodiment, only the translating component is considered.

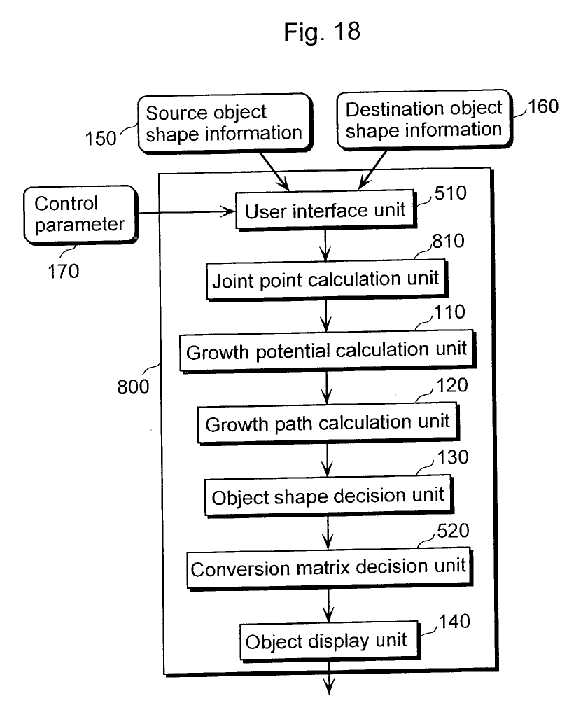

FIG. 18 is a diagram that shows an example of a structure of the object shape transformation device according to the fourth embodiment. An object shape transformation device 800 further comprises a joint point calculation unit 810 in addition to the functions shown in FIG. 10. Note that in FIG. 18, the same parts in FIG. 10 are given the same numbers and their explanations are omitted.

Since the object in the fourth embodiment also has the hierarchical structure, by transforming the shape of each segment, the relative position relationship between the segments that has the parent-child relationship changes and the problem explained in FIG. 11A occurs. To solve this problem, for a -start, the joint point calculation unit 810 of the object shape transformation device 800, using shape information of the source segments that have the parent-child relationship, calculates virtually the point where the source segments are connected (hereafter called “a joint point”). A method for calculating the joint point is explained below.

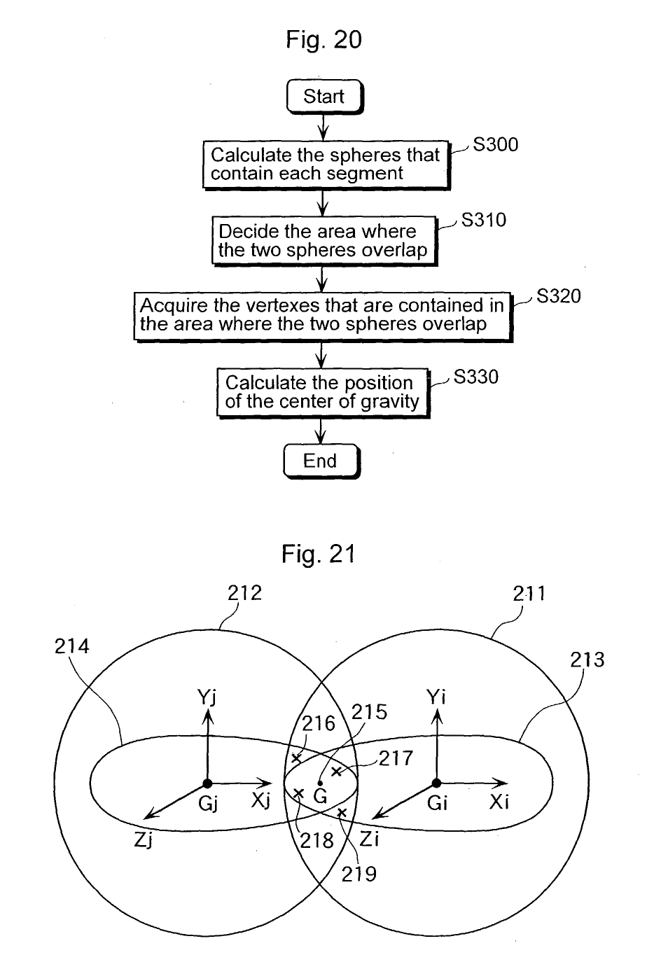

Let us think about calculating the joint point of the segment i and the segment j that have the parent-child relationship (refer to FIG. 20 and FIG. 21). The joint point calculation unit 810, for a start, as for the segments i 213 and j214, seeks spheres 211 and 212 that have positions of centers of gravity Gi and Gj of each segment at the center and contain whole the segment (S300). Next, the joint point calculation unit 810 determines the area where the two spheres overlap (S310) and acquires the vertexes 216˜219 that exist in the determined area among the vertexes that make up the segment i and the segment j (S320). Then, the joint point calculation unit 810 calculates again the position of the center of gravity G215 regarding a set of vertexes obtained by the above-mentioned processing (S330) and defines the obtained coordinates as the joint point of segment i 213 and the joint segment j 214. The coordinates of the joint point is represented by each local coordinate system. Subsequently, the calculated coordinates of the joint point is represented using the vertexes that make up each segment. For example, in the case of representing the joint point using the vertexes that make up the segment i 213, follow the procedures below. Here, the joint point shall be Ji.

(1) Select four arbitrary vertexes that do not exist in one plane among the vertexes that make up the segment. The selection method is not particularly limited but it is preferable to select vertexes that are near in distance to the joint point considering the processing to decide the conversion matrix that is described later.

(2) Suppose that the selected four vertexes are Pi0, Pi1, Pi2 and Pi3. Acquire three spatial vectors, v0↑=Pi1−Pi0, v1↑=Pi2−Pi0 and v2↑=Pi3−Pi0. Here, ↑represents a vector.

(3) Ji is represented using v0↑, v1↑ and v2↑. Ji=Pi0+α*v0 ↑+β*v 1↑+γ*v2↑

Here, α, β and γ are real numbers and * represents a product of the vector and the constant.

The above-mentioned processing is executed to the segment j 214. By the way, here, to calculate the joint point, the spheres that contain each segment are used, but it is acceptable to use other figures such as a circular cylinder and a prism. Additionally, using the source object shape information 150 where the origin point of the local coordinate system defined in each segment does not match the joint point and the parts object shape information 630, the joint point calculation unit 810, which is explained above, can be used to execute the shape transformation explained in the third embodiment. Here, in the case of transforming the shape using the object whose joint point does not match the origin point of the local coordinate system and of correcting the conversion matrix, note that it is necessary to correct not only the conversion matrix that represents the relationship between the segment that is focused and the segment that is its child but also the conversion matrix that represents the relationship between the segment that is focused and the segment that is its parent.

The conversion matrix decision unit 520 corrects the homogenous conversion matrix using the coordinates of the joint point calculated by the joint point calculation unit 810. At the time t, the segment i and the segment j are transformed by the parameters that are set up separately; suppose that the coordinates of the four vertexes selected by the joint point calculation unit 810 to represent the joint point are Pim0, Pim1, Pim2, Pim3, Pjm0, Pjm1, Pjm2 and Pjm3. Furthermore, suppose that the coordinates of the above-mentioned vertexes in the source object and the destination object are Pis0, Pis1, Pis2, Pis3, Pid0, Pid1, Pid2, Pid3, Pjs0, Pjs1, Pjs2, Pjs3, Pjd0, Pjd1, Pjd2 and Pjd3, respectively.

(1) The joint point Jis of the segment i in the source object, the joint point Jjs of the segment j in the source object, the joint point Jid of the segment i in the destination object, the joint point Jjd of the segment j in the destination object, the joint point Jim of the segment i in the object at the time t and the joint point Jjm of the segment j in the object at the time t are calculated using the following equations.

$$Jis = Pis0 + α i * vis0 ↑ + β i * vis1 ↑ + γ i * vis2 ↑ \\ Jim = Pim0 + α i * vim0 ↑ + β i * vim1 ↑ + γ i * vim2 ↑ \\ Jid = Pid0 + α i * vid0 ↑ + β i * vid1 ↑ + γ i * vid2 ↑ \\ Jjs = Pjs0 + α j * vjs0 ↑ + β j * vjs1 ↑ + γ j * vjs2 ↑ \\ Jjm = Pjm0 + α j * vjm0 ↑ + β j * vjm1 ↑ + γ j * vjm2 ↑ \\ Jjd = Pjd0 + α j * vjd0 ↑ + β j * vjd1 ↑ + γ j * vjd2 ↑ \\ Here , \\ Jis = ( xis , yis , zis ) , Jim = ( xim , yim , zim ) , Jid = ( xid , yid , zid ) , Jjs = ( xjs , yjs , zjs ) , Jjm = ( xjm , yjm , zjm ) , Jjd = ( xjd , yjd , zjd )$$

are the coordinates of the joint point at each time. Moreover, the following equations hold.

$$vis0 ↑ = Pis 1 - Pis 0 , vis 1 ↑ = Pis 2 - Pis 0 , vis 2 ↑ = Pis 3 - Pis 0 , \\ vim 0 ↑ = Pim 1 - Pim 0 , vim 1 ↑ = Pim 2 - Pim 0 , vim 2 ↑ = Pim 3 - Pim 0 , \\ vid 0 ↑ = Pid 1 - Pid 0 , vid 1 ↑ = Pid 2 - Pid 0 , vid 2 ↑ = Pid 3 - Pid 0 , \\ vjs0 ↑ = Pjs 1 - Pjs 0 , vjs 1 ↑ = Pjs 2 - Pjs 0 , vjs 2 ↑ = Pjs 3 - Pjs 0 , \\ vjm0 ↑ = Pjm 1 - Pjm 0 , vjm 1 ↑ = Pjsm 2 - Pjm 0 , vjm 2 ↑ = Pjm 3 - Pjm 0 , \\ vjd0 ↑ = Pjd 1 - Pjd 0 , vjd 1 ↑ = Pjsd 2 - Pjd 0 , vjd 2 ↑ = Pjd3 - Pjd 0$$

Here, ↑represents a vector. Further, αi, βi γi, αj, βj and γi are the constants obtained by the joint point calculation unit 810 and * represents a product of the vector and the constant.

(2) Seek dx, dy and dz, the ratio of change in each component, x, y and z, using the following equations.

$$dx = \frac{( \vert xim - xis \vert + \vert xjm - xjs \vert )}{( \vert xid - xis \vert + \vert xjd - xjs \vert ) ,}$$

$$dy = \frac{( \vert yim - yis \vert + \vert yjm - yjs \vert )}{( \vert yid - yis \vert + \vert yjd - yjs \vert ) ,}$$

$$dz = \frac{( \vert zim - zis \vert + \vert zjm - zjs \vert )}{( \vert zid - zis \vert + \vert zjd - zjs \vert )}$$

Here, |·| represents an absolute value.

(3) Seek (xi, yi, zi), the translating components of the homogenous conversion matrix Ai at the time t using the following equations.

$$xi = ( 1 - dx ) * xsi + dx * xdi , \\ yi = ( 1 - dy ) * ysi + dy * ydi , \\ zi = ( 1 - dz ) * zsi + dz * zdi , \\ Here , ( xsi , ysi , zsi ) and ( xdi , ydi , zdi ) are$$

the translating components of the homogenous conversion matrixes Asi and Adi that correspond to the segment i of the source object and the destination object, respectively.

The processing described above is executed to each conversion matrix following the hierarchical structure from the segment that corresponds to Root in sequence to the child.

Next, using the method explained in the first embodiment (the method for generating the transformation path of the object by operating the virtual force on the virtual mass point), a method for correcting the conversion matrix is described. For a start, the joint point calculation unit 810 seeks the coordinates of the joint points of the segment i and the segment j that have the parent-child relationship concerning the source object and the destination object. The calculated coordinates of the joint point are represented by the coordinate systems that are set up in the segment i and the segment j. Then, the conversion matrix decision unit 520 executes processing with the following procedures.

(1) Similarly to the processing to the vertexes that make up the segment, the conversion matrix decision unit 520 defines a virtual mass point and calculates the growth potential of the joint point using the parameters of α and β that the user interface unit 510 sets up.

(2) The conversion matrix decision unit 520 calculates the path of transformation of the joint point using the growth potential function of the joint point calculated in the above-mentioned (1).

(3) When the coordinates of joint point represented by the coordinate system that is set up in segment i at a certain time t is Jim=(xim, yim, zim) and the coordinates of joint point represented by the coordinate system that is set up in segment j at a certain time t is Jjm=(xjm, yjm, zjm), the conversion matrix decision unit 520 converts Jjm into the representation in the coordination system that is set up in the segment i, Jjm**i=(xjm**i, yjm**i, zjm**i).

(4) The translating components (xi, yi, zi)of the homogenous conversion matrix Ai is calculated using xi=xim-xjm**i, yi=yim−yj m**i and zi=zim-zjm**i.

The calculation method described above is applicable only when the area where the segments that have the parent-child relationship overlap exists.

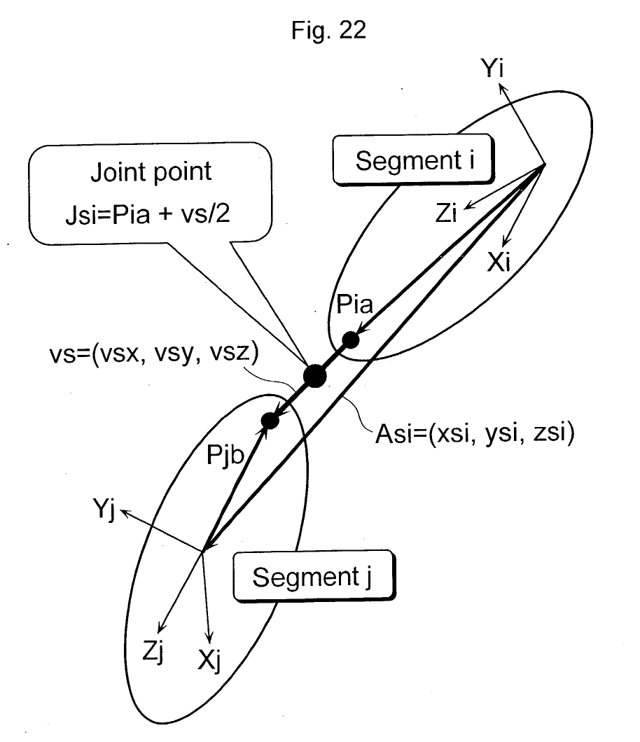

Next, the calculation method of the joint point in the case of no overlapping area is explained (refer to FIG. 22).

Similarly to the above-mentioned case, let us think about calculating the joint point of the segment i and the segment j that have the parent-child relationship. The processing in the joint point calculation unit 810 in the case of seeking the joint point of the source object follows procedures below.

(1) Seek the two vertexes that are nearest in distance among the vertexes that make up the segment i and the segment j.

(2) Suppose that the coordinates of the vertexes included in the segment i and the segment j calculated in the above-mentioned (1) are Pia and Pjb, respectively and convert Pjb into a representation in the coordinate system that is set up in the segment i.

(3) Suppose that the coordinates of the vertex converted in the above-mentioned (2) is Pjb**i and that the translating component of the homogenous conversion matrix is Asi=(xsi, ysi, zsi) and calculate the vector vs=(vsx, vsy, vsz) that is headed from Pia to Pjb using vs=Pjb**i−Pia.

(4) Calculate the joint point Jsi using Jsi=Pia+vs/2.

The processing described above is executed also to the segment j.

Additionally, similarly to the case in which the area where the segments that have the parent-child relationship overlap exists, the conversion matrix decision unit 520 calculates the coordinates of the joint point in the source object and the destination object and defines a virtual mass point to the joint point. Next, the conversion matrix decision unit 520 generates a transformation path by seeking the growth potential function in the joint point and corrects the conversion matrix based on the generated path.

As is described above, in the fourth embodiment, the object shape transformation device 800 comprises the joint point calculation unit that calculates the joint point of the segments that have the parent-child relationship regarding the object that has the hierarchical structure and therefore even in the case of using the object in which the origin point of the local coordinate system defined in each segment does not match the joint point, the user can control the transformation path of each segment.

What is claimed is:

1. An object shape transformation device that controls transformation of an object shape in computer graphics comprising:
a user interface unit operable to accept from a user a setting of (1) shape information of an object at time before and after the transformation and (2) a parameter that controls growth potential that is virtual force affecting shape transformation of the object;
a growth potential calculation unit operable to calculate the growth potential based on the set parameter;
a growth path calculation unit operable to calculate a transformation path of the object using the calculated growth potential;
an object shape decision unit operable to decide a shape of the object at predetermined time using a parameter that represents the calculated path of the transformation and time between the time before and after the transformation; and
an object display unit operable to display the object whose shape is decided.

2. The object shape transformation device according to claim 1,
wherein the growth potential calculation unit calculates the growth potential based on physical movement generated by force that operates on virtual mass point defined in a position of each vertex that makes up the object.

3. The object shape transformation device according to claim 1,
wherein the user interface unit further accepts a change of the set parameter from the user and updates the parameter, and
the growth path calculation unit changes the transformation path based on the parameter when the parameter is updated.

4. The object shape transformation device according to claim 1,
wherein the object is made up of one or plural segments,
the user interface unit further accepts setting of a structural hierarchy among the segments, a relative position relationship and shape information of individual segments at the time before and after the transformation;
the growth path calculation unit decides the transformation paths for the set individual segments;
the object shape decision unit decides the shapes of the individual segments at the predetermined time; and
the object shape transformation device further comprises a conversion matrix decision unit that decides the relative position relationship between the segments at the predetermined time.

5. The object shape transformation device according to claim 4,
wherein the conversion matrix decision unit specifies a connecting point of two segments that have a parent-child relationship, selects a vertex whose distance to the connecting point is the shortest among a set of vertexes that make up the parent segment as a representative point, and decides the relative position relationship of the segments that have the parent-child relationship based on a ratio of a change from coordinates of the representative point at the time before the transformation of the segment to the coordinates of the representative point at the predetermined time.

6. The object shape transformation device according to claim 4,
wherein the conversion matrix decision unit calculates a straight line passing through coordinates of an origin point of the parent segment and coordinates that represent coordinates of an origin point of the child segment by coordinate system of the parent segment, calculates a representative point based on a polygon that crosses the straight line and makes up the parent segment, seeks the ratio of the change from the coordinates of the representative point at the time before the transformation of the segment to the coordinates of the representative point at the predetermined time, and decides the relative position relationship of the segments that have the parent-child relationship.

7. The object shape transformation device according to claim 4 further comprising a joint point calculation unit operable to calculate a joint point where the segments that have the parent-child relationship connect,
wherein the conversion matrix decision unit seeks the ratio of the change from the coordinates of the joint point at the time before the transformation of the segment to the coordinates of the joint point at the predetermined time, and decides the relative position relationship of the segments that have the parent-child relationship.

8. The object shape transformation device according to claim 7,
wherein the conversion matrix decision unit defines a virtual mass point at a position of the joint point at the time before and after the transformation calculated by the joint point calculation unit, calculates the growth potential that operates on the joint point based on a parameter set by the user interface unit, decides a movement path of the joint point using the calculated growth potential, calculates coordinates of the joint point at the predetermined time using the decided movement path of the joint point, and decides the relative position relationship of the segments that have the parent-child relationship based on the calculated coordinates of the joint point.

9. The object shape transformation device according to claim 7,
wherein the joint point calculation unit calculates graphics containing the segments that have the parent-child relationship for each segment, decides an area that each graphic overlaps, acquires vertexes that exist in the overlapped area among vertexes that make up the segments that have the parent-child relationship, and calculates the joint point using a set of the acquired vertexes.

10. The object shape transformation device according to claim 8,
wherein the joint point calculation unit acquires two vertexes that are located in the points where a distance between the segments that have the parent-child relationship is shortest among vertexes that make up each segment that has the parent-child relationship where no overlapped area exists, and calculates the joint point using the two acquired vertexes.

11. The object shape transformation device according to claim 4,
wherein the user interface unit further accepts a setting specifying the structural hierarchy among the segments, the relative position relationship and the shape information of individual segments before the transformation and a setting specifying the shape information of the individual segments and the position information of the points where the individual segments connect with other segments after the transformation, and
the conversion matrix decision unit changes the relative position relationship among the segments at the time before the transformation based on the shape of the individual segments calculated by the object shape decision unit.

12. The object shape transformation device according to claim 11,
wherein the user interface unit further includes a memory unit that stores shape information of plural segments in advance at the time after the transformation and accepts selection of shape information of an arbitrary segment from the user.

13. The object shape transformation device according to claim 11,
wherein the conversion matrix decision unit converts the coordinates of the origin point of the child segment into the coordinates represented by the coordinate system of the parent segment, selects the vertex whose distance to the origin point is shortest among a set of vertexes that make up the parent segment as a representative point, seeks the ratio of the change from the coordinates of the representative point at the time before the transformation of the segment to the coordinates of the representative point at the predetermined time, and decides the relative position relationship of the segments that have the parent-child relationship.

14. The object shape transformation device according to claim 11 further comprising a joint point calculation unit operable to calculate a joint point where two segments that have the parent-child relationship connect at the time before the transformation,
wherein the conversion matrix decision unit decides the relative position relationship of the segments that have the parent-child relationship based on a ratio of a change from coordinates of the joint point at time before the transformation of the segment to the coordinates of the joint point at the predetermined time.

15. The object shape transformation device according to claim 14,
wherein the joint point calculation unit calculates graphics containing the segments that have the parent-child relationship for each segment at the time before the transformation, decides an area that each graphic overlaps, acquires vertexes that exist in the overlapped area among vertexes that make up the segments that have the parent-child relationship, and calculates the joint point using a set of the acquired vertexes.

16. The object shape transformation device according to claim 1,
wherein the growth potential is represented by a function that combines a linear function and a constant function.

17. The object shape transformation device according to claim 1,
wherein the parameter is used to control each ratio of a period in which the shape transformation is executed with an accelerated speed, a period in which the shape transformation is executed with an decelerated speed and a period in which the shape transformation is executed with a constant speed.

18. An object shape transformation method for controlling transformation of an object shape in computer graphics including:
a user interface step for accepting from a user a setting of (1) shape information of an object at time before and after the transformation and (2) a parameter that controls growth potential that is virtual force affecting shape transformation of an object;
a growth potential calculation step for calculating the growth potential based on the set parameter;
a growth path calculation step for calculating a transformation path of an object using the calculated growth potential;
an object shape decision step for deciding a shape of the object at predetermined time using a parameter that represents the calculated path of the transformation and time between the time before and after the transformation; and
an object display step for displaying the object whose shape is decided.

19. The object shape transformation method according to claim 18,
wherein the object is made up of one or plural segments, the user interface step further accepts setting of a structural hierarchy among the segments, a relative position relationship and shape information of individual segments at the time before and after the transformation;
the growth path calculation step decides the transformation paths for the set individual segments;
the object shape decision step decides shapes of the individual segments at the predetermined time, and
the object shape transformation method further includes a conversion matrix decision step that decides the relative position relationship between the segments at the predetermined time.

20. The object shape transformation method according to claim 19,
wherein the user interface unit further accepts a setting specifying the structural hierarchy among the segments, the relative position relationship and the shape information of individual segments before the transformation and a setting specifying the shape information of the individual segments and the position information of the points where the individual segments connect with other segments after the transformation, and
the conversion matrix decision step changes the relative position relationship among the segments at the time before the transformation based on the shape of the individual segments calculated by the object shape decision step.

21. A program for an object shape transformation device that controls transformation of an object shape in computer graphics causes a computer to execute:
a user interface step for accepting from a user a setting of (1) shape information of an object at time before and after the transformation and (2) a parameter that controls growth potential that is virtual force affecting shape transformation of an object;
a growth potential calculation step for calculating the growth potential based on the set parameter;
a growth path calculation step for calculating a transformation path of an object using the calculated growth potential;
an object shape decision step for deciding a shape of the object at predetermined time using a parameter that represents the calculated path of the transformation and time between the time before and after the transformation; and
an object display step for displaying the object whose shape is decided.
